(19) United States
(12) Patent Application Publication
(10) Pub. No.: US 2024/0372064 A1
(43) Pub. Date: Nov. 7, 2024

(54) REUSEABLE PORTABLE ELECTRIC POWER GENERATION APPARATUS AND METHOD OF USING

(71) Applicant: Wireless Electrical Grid LAN, WiGL Inc., Hampton, VA (US)

(72) Inventors: Ahmad L.D. Glover, Hampton, VA (US); Alfred Lewis Anderson, Houston, TX (US)

(73) Assignee: Wireless Electrical Grid LAN, WiGL Inc., Hampton, VA (US)

(21) Appl. No.: 18/769,881

(22) Filed: Jul. 11, 2024

Related U.S. Application Data
(63) Continuation-in-part of application No. 18/129,020, filed on Mar. 30, 2023.

(51) Int. Cl. H01M 4/06; H01M 4/38; H01M 4/583; H01M 4/74; H01M 6/04; H01M 6/32

(52) U.S. Cl. CPC H01M 4/06; H01M 4/381; H01M 4/583; H01M 4/74; H01M 6/04; H01M 6/32; H01M 2220/30

(57) ABSTRACT

A static dissipative single use glove having a vertical resistivity of less than or equal to about 10⁸ Ohm when determined according to EN 1149-2 and surface resistivity of less than or equal to about 10⁶ Ohm when determined according to EN 1149-1, which includes a polymeric layer comprising conductive filler particles. A method to produce the single use glove is also disclosed.

### CROSS-REFERENCES TO RELATED APPLICATIONS

This application is a continuation-in-part of co-pending U.S. patent application Ser. No. 18/129,020, filed Mar. 30, 2023, the contents of which are fully incorporated by reference herein.

### FIELD

The instant disclosure is generally directed to a reusable, portable electric power generation apparatus, more particularly, to a salt water battery disposed within a refillable housing and a replaceable anode, having a size similar to a personal water bottle which may be activated by directing water into the apparatus.

### BACKGROUND

Electrical power is necessary for electric devices to function. Providing electrical power to devices not connected with a land-based power grid, or to mobile devices, or moving electrically powered vehicles requires a physical electrical connection between a stationary power source and the electric device.

Electric devices in operation and remote electrical devices are not readily connectable to a wired power grid. Providing electrical power to recharge electric storage batteries which power electrically powered devices typically requires taking the device out of operation. However, in some instances this is not possible, e.g., when doing so would put the end user in danger or in an emergency situation.

Providing electrical power to recharge electric storage batteries which power electrically powered devices in remote environments, and/or directly powering electrical devices in remote locations, which for purposes herein refers to environments devoid of electrical connections to a power grid, typically requires providing power generation equipment, typically powered by a combustible fuel source, or charging a power source via a grid connection e.g., charging a storage battery, and then carting the battery to the remote location to either recharge or replace the depleted electric storage batteries as the remote location. However, in various situations this is not readily possible or economical due to external factors such as armed conflicts or natural disasters despite the fact that human lives may depend on having the electrical power.

In other situations, such storage batteries may be recharged using solar power. However, such power is only available while the sun is shining, limiting the ability to generate power. Furthermore, solar power is not suitable for situations where emergency power may be required. In other situations, an electric battery may be charged and then utilized for such purposes. However, electrical batteries have definitive shelf life and once depleted, must be disposed or require an electrical power source to recharge.

There is need for an apparatus and system capable of providing electrical power to recharge electric storage batteries which power electrically powered devices, and/or which directly power electrical devices such as communication and other devices, in remote environments, and/or which are suitable to provide emergency power on demand. This need extends to situations which do not require a combustible fuel source or charging a power source via a grid connection drawing power from a land-based electric grid, or by a generator which converts mechanical energy into electric power.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter. In embodiments, a reusable portable electric power generation apparatus comprises a housing having a plurality of sides, one of more of the sides having a plurality of fenestrations disposed therethrough, the housing surrounding an anode, the anode at least partially surrounding, and spaced apart from a cathode, forming a liquid reservoir between an inner water impermeable side of the anode and the cathode, wherein the anode comprises a Group 1, 2, 12 or 13 metal; wherein the cathode comprises a Group 8-11 metal, and/or carbon electrode disposed between the inner water impermeable side and an outer semipermeable membrane; wherein the metal electrode is in fluid communication with an external atmosphere through the semipermeable membrane through the plurality of fenestrations; wherein the semipermeable membrane is in fluid communication with the liquid reservoir such that a liquid disposed within the liquid reservoir provides fluid communication between the cathode and the metal electrode; wherein the liquid reservoir is in fluid communication with the external atmosphere through a re-closable opening of the housing, and wherein the cathode and the metal electrode are in electrical communication with a power outlet.

In embodiments, a method of generating electric power, comprises directing an aqueous liquid through a re-closable opening in a housing of a portable electrical power generation apparatus into a liquid reservoir, wherein the housing comprises a plurality of sides, one of more of the sides having a plurality of fenestrations disposed therethrough, the housing surrounding an anode, the anode at least partially surrounding, and spaced apart from a cathode, forming the liquid reservoir between an inner water impermeable side of the anode and the cathode, wherein the anode comprises a Group 1, 2, 12 or 13 metal; wherein the cathode comprises a Group 8-11 metal, and/or carbon electrode disposed between the inner water impermeable side and an outer semipermeable membrane; wherein the metal electrode is in fluid communication with an external atmosphere through the semipermeable membrane through the plurality of fenestrations; wherein the semipermeable membrane is in fluid communication with the liquid reservoir such that the liquid disposed within the liquid reservoir provides fluid communication between the cathode and the metal electrode; and wherein the cathode and the metal electrode are in electrical communication with a power outlet.

Various advantages, aspects and novel features of the present disclosure, as well as details of an illustrated embodiment thereof, will be more fully understood from the following description and drawings.

### DESCRIPTION OF THE DRAWINGS

So that the manner in which the above recited features of embodiments of the instant disclosure can be understood in detail, a more particular description of the embodiments, briefly summarized above, may be had by reference to embodiments, some of which are illustrated in the appended drawings. It is to be noted, however, that the appended drawings illustrate only illustrative embodiments of this disclosure and are therefore not to be considered limiting of its scope, for the invention disclosed herein may admit to other equally effective embodiments.

FIG. 1 depicts a side-on view of a portable electric power generation apparatus according to embodiments disclosed herein;

FIG. 2 depicts a cross sectional view of a portable electric power generation apparatus according to embodiments disclosed herein;

FIG. 3 depicts an exploded view of a portable electric power generation apparatus according to embodiments disclosed herein;

FIG. 4 depicts an overhead view an cylindrical anode according to embodiments disclosed herein;

FIG. 5 depicts a side view of the cylindrical anode shown in FIG. 4;

FIG. 6 depicts an overhead view a two part anode according to embodiments disclosed herein;

FIG. 7 depicts a side view of the two part anode shown in FIG. 6;

FIG. 8 depicts an overhead view a three part anode according to embodiments disclosed herein;

FIG. 9 depicts a side view of the three part anode shown in FIG. 8;

FIG. 10 depicts an side view of a single electrode cathode according to embodiments disclosed herein;

FIG. 11 depicts an overhead view of the single electrode cathode shown in FIG. 10, disposed around a cylindrical anode according to embodiments disclosed herein;

FIG. 12 depicts an side view of a two part electrode cathode according to embodiments disclosed herein;

FIG. 13 depicts an overhead view of the two-part electrode cathode shown in FIG. 12, disposed around a cylindrical anode according to embodiments disclosed herein;

FIG. 14 depicts an overhead view of the two-part electrode cathode shown in FIG. 12, disposed around a two-part anode according to embodiments disclosed herein;

FIG. 15 is an exploded view of a cathode disposed within an inner support of the housing according to embodiments disclosed herein;

FIG. 16 is an exploded view of a two-part cathode disposed within an inner support of the housing according to embodiments disclosed herein; and

FIG. 17 is a flowchart depicting a method of generating power according to embodiments disclosed herein.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Likewise, each limitation of an embodiment should be read once as comprising that embodiment, then again as consisting essentially of that embodiment, then again as consisting of that embodiment, unless otherwise indicated. For brevity, the term comprising is used throughout unless otherwise indicated.

The following definitions are provided in order to aid those skilled in the art in understanding the detailed description.

As used in the specification and claims, “near” is inclusive of “at.”

For use herein, the expressions “have”, “may have”, “include”, “comprise”, “may include”, and “may comprise” indicate the existence of corresponding features (e.g., such as numeric values, functions, operations, or components) but do not exclude the presence of additional features.

In the present disclosure, expressions such as, “A or B” represents an alternative selection which, for example, refer to the case (1) where A is included or (2) where B is included, but does not represent the case where both A and B are included.

In the present disclosure, expressions such as, “A and/or B”, “at least one of A and/or B”, “one or more of A and/or B”, and the like, refer to a case which may include any and all combinations of one or more of the associated listed items. For example, the terms “A and/or B”, and “at least one of A or B” may refer to the case (1) where A is included, (2) where B is included, or (3) where both A and B are included.

Terms such as “first”, “second”, and the like used herein may refer to various elements of various embodiments disclosed herein, but it is to be understood that these labels do not limit the elements to any particular order, amount, or importance; such terms are used only to distinguish an element from another element and do not limit the order and/or priority of the elements. Likewise, such terms are used relative to others and do not represent absolute location, place, or order. For example, without departing from the scope of the present disclosure, a first element of one embodiment may be referred to as a second element in another embodiment, and similarly, a second element may be referred to as a first element.

In embodiments, a reusable, portable electric power generation apparatus, comprises a housing having a plurality of sides, one of more of the sides having a plurality of fenestrations disposed therethrough, the housing surrounding a cathode, the cathode at least partially surrounding, and spaced apart from an anode, forming a liquid reservoir between an inner water impermeable side of the cathode and the anode, wherein the anode comprises a Group 1, 2, 12 or 13 metal; wherein the cathode comprises a Group 8-11 metal, and/or carbon electrode disposed between the inner water impermeable side and an outer semipermeable membrane; wherein the metal electrode is in fluid communication with an external atmosphere through the semipermeable membrane through the plurality of fenestrations; wherein the semipermeable membrane is in fluid communication with the liquid reservoir such that a liquid disposed within the liquid reservoir provides fluid communication between the anode and the metal electrode; wherein the liquid reservoir is in fluid communication with the external atmosphere through a re-closable opening of the housing, wherein the anode and the metal electrode are in electrical communication with a power outlet, and wherein the housing further comprises a resealable opening, through which the liquid reservoir may be emptied and the anode replaced.

In embodiments, the cathode comprises a Group 8-11 metal electrode, which in embodiments is a wire mesh or foam. In embodiments, the cathode comprises graphite or other forms of elemental carbon. In embodiments, the outer semipermeable membrane of the cathode comprises graphite. In embodiments, the metal electrode comprises iron, cobalt, nickel, and/or copper. In embodiments, the anode comprises lithium, magnesium, zinc and/or aluminum metal. In embodiments, the anode comprises a plurality of magnesium metal structures having a cylindrical or rectangular shape, which are connected together on a bottom portion.

In embodiments, the portable electric power generation apparatus further comprises a pressure vent in fluid communication with the liquid reservoir. In embodiments, the power outlet comprises a power converter, configured to output a voltage of at least 4.5 volts. In embodiments, wherein the inner water impermeable side of the cathode comprises a polyolefin film.

In embodiments, a method of generating power comprises directing an aqueous liquid through a re-closable opening in a housing of a portable electrical power generation apparatus into a liquid reservoir according to embodiments disclosed herein. In embodiments, the aqueous liquid comprises a salt. In other embodiments, the liquid reservoir further comprises a water soluble salt.

In embodiments, the portable electric power generation apparatus utilizes a salt water battery to generate electrical power. In embodiments, the anode is a group 2 metal, which in embodiments is in metallic form i.e., an oxidation state of zero. In embodiments, the anode comprises magnesium in the form of an alloy with other metals, or consists essentially of magnesium metal. The cathode is typically a group 8-11 metal, with iron, cobalt, nickel, and/or copper being among the suitable materials. In embodiments, the cathode comprises elemental carbon, e.g., graphite, graphene, carbon nanotubes, or a combination thereof. In embodiments, the cathode is a metallic mesh or foam comprising copper, nickel, or an alloy thereof.

In embodiments, the cathode comprises a laminate comprising a metallic mesh or foam disposed between an inner water impermeable side, and an outer semipermeable membrane. The outer membrane of the cathode is semipermeable to oxygen, which is provided to the cell for oxidation of the anode. Suitable semipermeable outer membranes include various graphite impregnated woven or non-woven substrates, e.g., carbon felts, and the like, having a porosity and electrical conductivity sufficient to allow oxygen to enter into the electrolyte.

Both the anode and the cathode are in electrical communication with the power output of the portable electrical power generation apparatus, which in embodiments includes a power converter system or circuit configured to convert the voltage produced by the galvanic cell to an output voltage of at least 4.5 volts, e.g., a nominal 5V DC output via a USB or other connector, to allow use of the electrical power by various electronic devices.

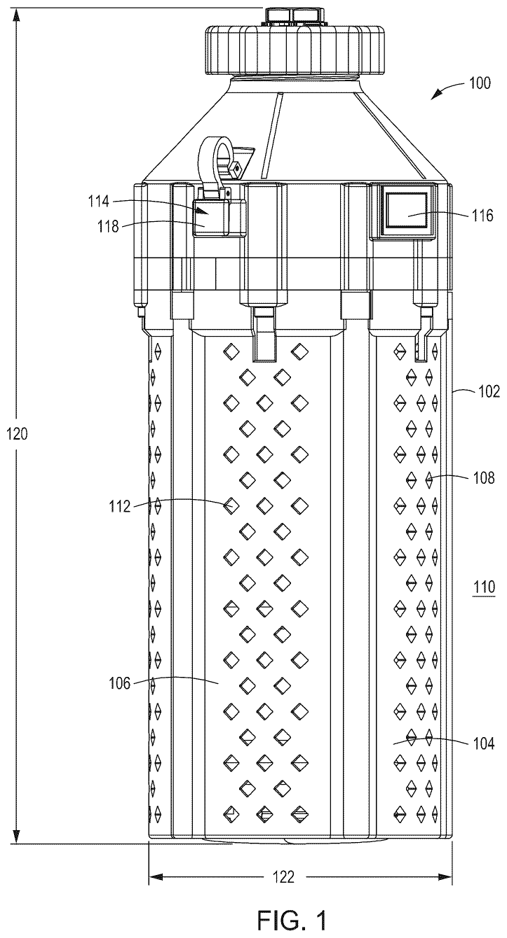

Turning to FIG. 1, a portable electrical power generation apparatus 100, “the apparatus”) is depicted comprising a housing 102 having a plurality of sides 104 and 106, wherein one of more of the sides 104 and 106 having a plurality of fenestrations 108 disposed therethrough. These fenestrations provide fluid communication between the external atmosphere 110 and the cathode 112 located within the housing 102

As shown in FIG. 1, in embodiments, the apparatus 100 comprises a power outlet 114, which is shown behind a protective cover 118, and my further include an on/off switch 116 that allows electrical power to flow through the power outlet 114. In embodiments, the apparatus has a size consistent with a hand-held water bottle. In embodiments, the apparatus has a height 120 of less than or equal to about 30 cm, and a width 122 of less than or equal to about 15 cm to allow the apparatus to be easily carried and stored.

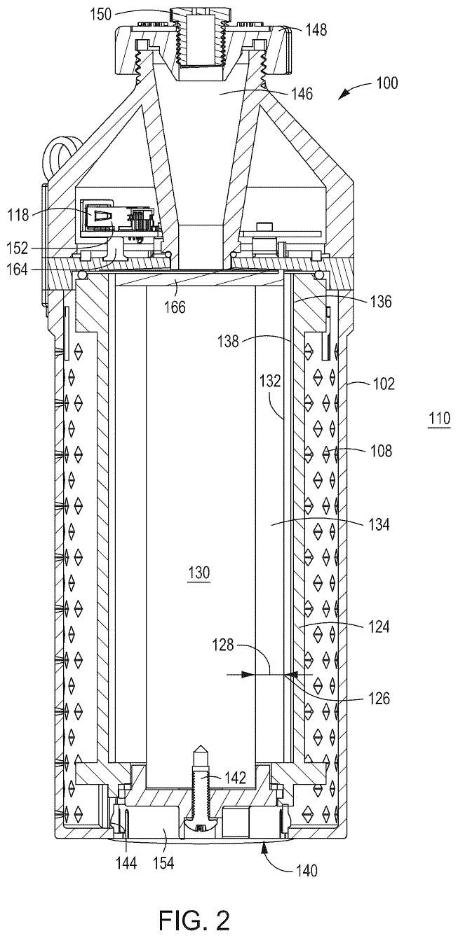

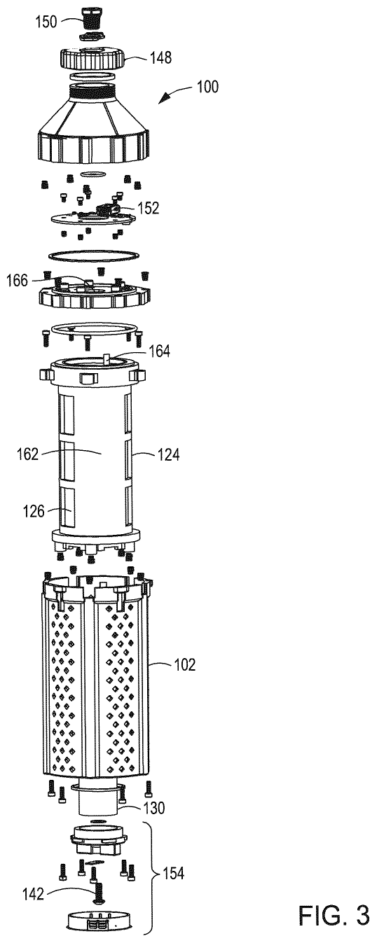

FIG. 2 shows a cross-sectional view of the apparatus 100. FIG. 3 depicts an exploded view of the apparatus 100 according to embodiments disclosed herein.

The housing 102 comprising and inner support 124 surrounding a cathode 126. The cathode 126 at least partially surrounding, and spaced apart from, via spacing 128, an anode 130. The spacing 128 between an inner water impermeable side 132 of the cathode 126 and the anode 130 forming a liquid reservoir 134 located between the inner water impermeable side 132 of the cathode 126 and the anode 130.

The cathode 126 further includes a metal electrode 138 disposed between the inner water impermeable side 132 and an outer an outer semipermeable membrane 136, which is in fluid communication with the external atmosphere 110 i.e., the oxygen present in the air, through the plurality of fenestrations 108.

In embodiments, the housing 102 of the apparatus 100 further comprises a resealable opening, i.e., bottom opening 140, through which the liquid reservoir 134 may be emptied and the anode 130 replaced. In embodiments, replacement anodes may be provided to allow regeneration of the apparatus. As shown in FIG. 2, the anode 130 may be attached to the bottom opening assembly 154 via a threaded member. The bottom opening 140 may further include tabs, threads, and/or the like 144 to releasably engage the bottom opening assembly 154 with a corresponding portion of the housing 102 to sealingly engage the bottom opening assembly 154 with the housing 102 and provide a portion of the liquid reservoir 134.

In embodiments, the liquid reservoir 134 is in fluid communication with the external atmosphere 110 through a re-closable opening 146 of the housing, which in embodiments includes a funnel shape to direct the liquid into the liquid reservoir 134. In embodiments, the re-closable opening 146 is sealed with a screw cap 148 to allow filling of the liquid reservoir 134 with the aqueous electrolyte, e.g., salt water, which activates the apparatus 100. In embodiments, the apparatus 100 further comprises a pressure vent 150 in fluid communication with the liquid reservoir 134 to allow for thermal expansion.

In embodiments, the cathode 126 includes one or more electrical connectors 164 which connect to the power converter system 152, and the anode 130 includes an electrical connection 166 with the power converter system 152 as well.

The voltage produced by the apparatus is a function of the reduction potential of the anode. A magnesium anode will typically produce a voltage on the order of 0.9V. While a plurality of electrodes may be used, each producing a corresponding voltage, the native voltage may not be suitable for use in charging or powering electronic devices. Accordingly, in embodiments, the apparatus further comprises a power outlet having a power converter system 152 or circuit configured to output a voltage of at least 4.5 volts, which is a nominal 5V suitable for use with a USB connector and power system. FIG. 3 depicts an exploded view according to embodiments disclosed herein.

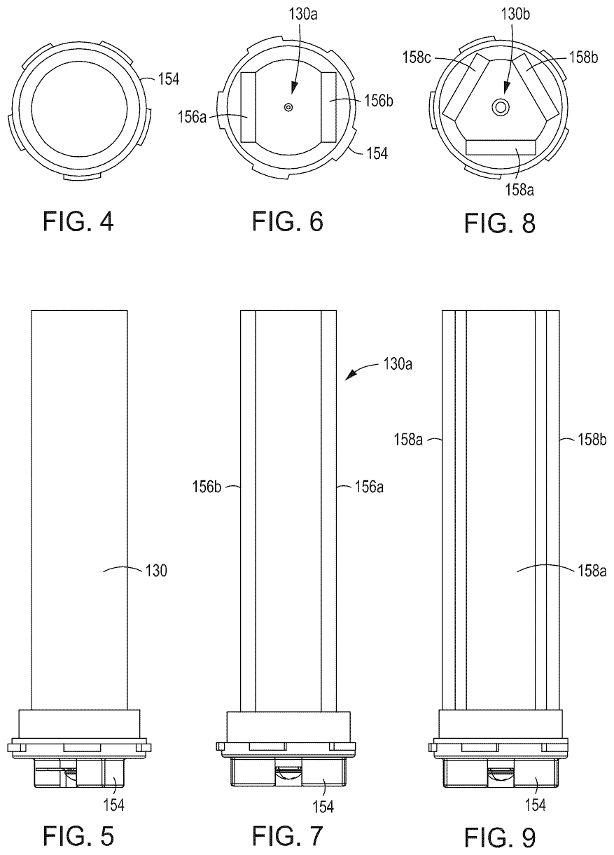

FIG. 4 depicts a top down view and FIG. 5 depicts a side view of an anode 130 disposed within the bottom opening assembly 154 in which the anode 130 is cylindrical in shape. FIG. 6 depicts a top down view and FIG. 7 depicts a side view of a two-part anode 130a comprising two rectangular shaped anodes 156a and 156b, which are connected together on a bottom portion, disposed within the bottom opening assembly 154. FIG. 8 depicts a top down view and FIG. 9 depicts a side view of a three-part anode 130b comprising three rectangular shaped anodes 158a, 158b, and 158c, which are connected together on a bottom portion, disposed within the bottom opening assembly 154. Accordingly, in embodiments, the anode comprises a plurality of magnesium metal structures having a cylindrical or rectangular shape, which are connected together on a bottom portion.

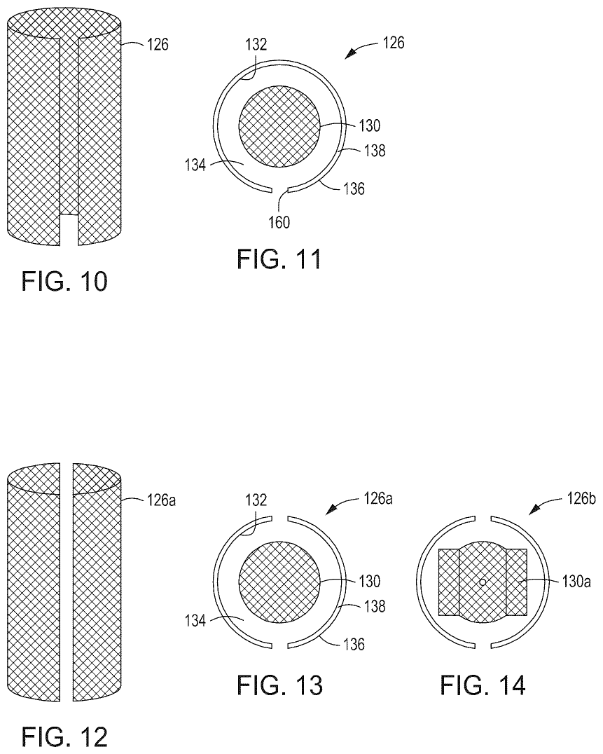

FIG. 10 depicts a cathode 126 shaped to surround an anode 130 as shown in the overhead view of the cathode 126 surrounding anode 130 in FIG. 11. The cathode 126 comprises a metal electrode 138 disposed between the inner water impermeable side 132 and an outer an outer semipermeable membrane 136.

FIG. 12 depicts a two-part cathode 126a shaped to surround an anode 130 as shown in the overhead view of the two-part cathode 126a surrounding a cylindrical anode 130 in FIG. 13. The cathode 126 comprises a metal electrode 138 disposed between the inner water impermeable side 132 and an outer an outer semipermeable membrane 136.

FIG. 14 is an overhead view of the two-part cathode 126a shown in FIG. 12 surrounding a two-part anode 130a (see FIGS. 6 and 7).

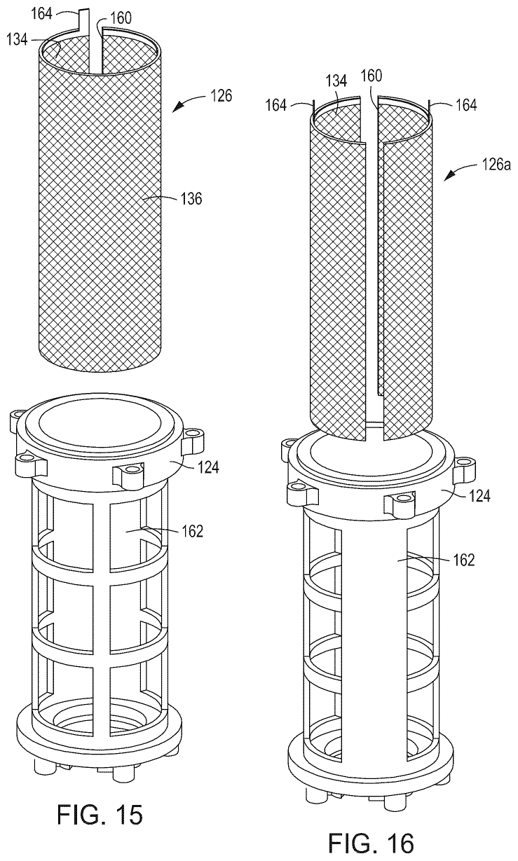

As shown in FIG. 11, in embodiments, a portion 160 of the outer semipermeable membrane 136 is in fluid communication with the liquid reservoir 134, which in embodiments is along the various edges of the cathode 126. As shown in FIGS. 15 and 16, in embodiments, the edges of the cathode 126 are arranged behind a solid portion 162 (see also FIG. 3) of the inner support 124. In embodiments, the cathode 126 is attached to the inner support 124 via a water-proof adhesive to form the liquid reservoir 134.

In embodiments, the cathode 126 includes one or more electrical connectors 164 which connect to the power converter system 152 (see FIG. 2).

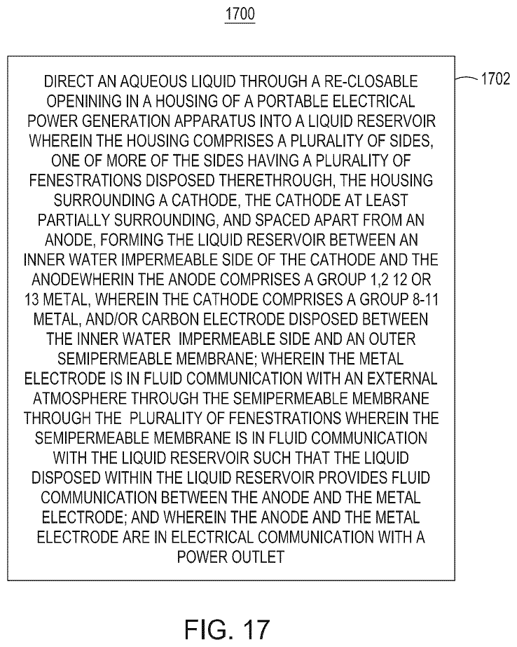

As shown in FIG. 17, in embodiments, a method of generating power comprises directing an aqueous liquid through the re-closable opening in the housing of the apparatus into the liquid reservoir. In embodiments, the aqueous liquid comprises a salt, e.g., salt water, in other embodiments, the liquid reservoir further includes an amount of an ionic material, e.g., a salt such as sodium chloride, such that upon directing an aqueous liquid into the liquid reservoir, electrical connection is established between the anode and the cathode and the apparatus generates electrical power.

In embodiments, an anode to cathode area ratio is greater than or equal to about 50%, or greater than or equal to about 60%, or greater than or equal to about 65%.

In embodiments, the apparatus is capable of producing a current of greater than or equal to about 700 mA, or greater than or equal to about 750 mA, or greater than or equal to about 800 mA, or greater than or equal to about 850 mA at 5 volts.

A portable electrical power generation apparatus according to embodiments disclosed herein having a cathode reaction area of about 225 cm² and the anode reaction area 150 cm², resulting in an anode to cathode area ratio of about 66%. Such an apparatus in a single cell configuration is capable of producing 765.87 mA at 5V. An apparatus having a two-part cathode, forming two separate cells with a single anode, is capable of producing a current of 888.2 mA at 5V.

In embodiments, the portable electrical power generation apparatus has overall dimensions similar to a one liter water bottle, and may be stored for an essentially indefinite period of time in a desiccated environment, e.g., a foil pack. Upon removal of the apparatus from storage, the apparatus may be activated by directing water or salt water into the liquid reservoir and begin producing electrical power suitable to power and/or recharge electronic devices. In embodiments, the bottom cap may be removed, and the anode replaced. The apparatus may then again be activated with salt water to generate electrical power in remote areas, during emergency situations, or other similar environments and/or conditions.

The foregoing disclosure and description of the invention is illustrative and explanatory thereof and it can be readily appreciated by those skilled in the art that various changes in the size, shape and materials, as well as in the details of the illustrated construction or combinations of the elements described herein can be made without departing from the spirit of the invention.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

We claim:

1. A portable electric power generation apparatus, comprising:
a housing having a plurality of sides, one of more of the sides having a plurality of fenestrations disposed therethrough,
the housing surrounding a cathode, the cathode at least partially surrounding, and spaced apart from an anode, forming a liquid reservoir between an inner water impermeable side of the cathode and the anode,
wherein the anode comprises a Group 1, 2, 12 or 13 metal;
wherein the cathode comprises a Group 8-11 metal, and/or carbon electrode disposed between the inner water impermeable side and an outer semipermeable membrane;
wherein the metal electrode is in fluid communication with an external atmosphere through the semipermeable membrane through the plurality of fenestrations;
wherein the semipermeable membrane is in fluid communication with the liquid reservoir such that a liquid disposed within the liquid reservoir provides fluid communication between the anode and the metal electrode;
wherein the liquid reservoir is in fluid communication with the external atmosphere through a re-closable opening of the housing,
wherein the anode and the metal electrode are in electrical communication with a power outlet; and
wherein the housing further comprises a resealable opening, through which the liquid reservoir may be emptied and the anode replaced.

2. The portable electrical power generation apparatus of claim 1, wherein the Group 8-11 metal electrode of the cathode is a wire mesh.

3. The portable electrical power generation apparatus of claim 1, wherein the cathode comprises graphite.

4. The portable electrical power generation apparatus of claim 1, wherein the metal electrode comprises nickel and/or copper.

5. The portable electrical power generation apparatus of claim 1, wherein the anode comprises magnesium metal.

6. The portable electrical power generation apparatus of claim 1, wherein the anode comprises a plurality of magnesium metal structures having a cylindrical or rectangular shape, which are connected together on a bottom portion.

7. The portable electrical power generation apparatus of claim 1, further comprising a pressure vent in fluid communication with the liquid reservoir.

8. The portable electrical power generation apparatus of claim 1, wherein the power outlet comprises a power converter, configured to output a voltage of at least 4.5 volts.

9. The portable electrical power generation apparatus of claim 1, wherein the inner water impermeable side of the cathode comprises a polyolefin film.

10. A method of generating power, comprising:
Directing an aqueous liquid through a re-closable opening in a housing of a portable electrical power generation apparatus into a liquid reservoir, wherein the housing comprises a plurality of sides, one of more of the sides having a plurality of fenestrations disposed therethrough,
the housing surrounding a cathode, the cathode at least partially surrounding, and spaced apart from an anode, forming the liquid reservoir between an inner water impermeable side of the cathode and the anode,
wherein the anode comprises a Group 1, 2, 12 or 13 metal;
wherein the cathode comprises a Group 8-11 metal, and/or carbon electrode disposed between the inner water impermeable side and an outer semipermeable membrane;
wherein the metal electrode is in fluid communication with an external atmosphere through the semipermeable membrane through the plurality of fenestrations;
wherein the semipermeable membrane is in fluid communication with the liquid reservoir such that the liquid disposed within the liquid reservoir provides fluid communication between the anode and the metal electrode; and
wherein the anode and the metal electrode are in electrical communication with a power outlet.

11. The method of claim 10, wherein the Group 8-11 metal electrode of the cathode is a wire mesh.

12. The method of claim 10, wherein the outer semipermeable membrane of the cathode comprises graphite.

13. The method of claim 10, wherein the metal electrode comprises copper.

14. The method of claim 10, wherein the anode comprises magnesium metal.

15. The method of claim 10, wherein the housing further comprises a resealable opening, through which the liquid reservoir may be emptied and the anode replaced.

16. The method of claim 10, wherein the portable electrical power generation apparatus further comprises a pressure vent in fluid communication with the liquid reservoir.

17. The method of claim 10, wherein the power outlet comprises a power converter, configured to output a voltage of at least 4.5 volts.

18. The method of claim 10, wherein the inner water impermeable side of the cathode comprises a polyolefin film.

19. The method of claim 10, wherein the aqueous liquid comprises a salt.

20. The method of claim 10, wherein the liquid reservoir further comprises a water soluble salt.
